(19) United States
(12) Patent Application Publication
(10) Pub. No.: US 2022/0282979 A1
(43) Pub. Date: Sep. 8, 2022

(54) System and Method for Generating and Optimizing Dynamic Dispatch Plans

(71) Applicant: Delhivery Private Limited, Gurgaon, Haryana (IN)

(72) Inventors: Kabir Rustogi, New Delhi (IN); Rahul Kumar, Haryana (IN); Rishit Jain, Delhi (IN); Shiv Krishna Jaiswal, Jaunpur (IN)

(73) Assignee: Delhivery Private Limited, Gurgaon, Haryana (IN)

(21) Appl. No.: 17/653,186

(22) Filed: Mar. 2, 2022

(30) Foreign Application Priority Data
Mar. 3, 2021 (IN) 202111008877

(51) Int. Cl. G01C 21/34; G01C 21/00

(52) U.S. Cl. CPC G01C 21/3438; G01C 21/3885; G01C 21/387

(57) ABSTRACT

Disclosures in the present invention relate to a system and method of generating and optimising real time dynamic dispatch plans. The system in the present invention stores dispatch data which includes location identification data i.e. addresses/locations of the entities serviced as well as the route taken by the dispatch vehicle during the dispatch. Location identification data of two dispatches is compared with each other to identify highly overlapping geographic clusters and the boundary between such geographic clusters. Over time, this process is repeated and the boundaries thus identified are regarded as constraints to be used in dispatch planning. As such, two entities which lie in a single geographic cluster with no boundary between them are deemed to be capable of being serviced together in a single dispatch, whereas caution may be exercised while servicing entities that lie in separate geographic clusters.

### CROSS-REFERENCES TO RELATED APPLICATIONS

This Non-Provisional Application claims the benefit of and priority to Indian Patent Application Serial No. 202111008877, filed Mar. 3, 2021, entitled “System and Method for Generating and Optimizing Dynamic Dispatch Plans,” the entire contents of which is hereby incorporated herein by reference.

### FIELD OF INVENTION

Embodiments of the disclosure relate generally to the field of machine learning, artificial intelligence and data interpretation. More particularly, embodiments of the disclosure relate to a system and method for dynamic generation of item-dispatch plans.

### BACKGROUND

Last-mile delivery is defined as the movement of goods from a transportation origin to the final delivery destination. In recent years, last-mile delivery services have been widespread in applications like urban logistics, e-commerce, food delivery etc.

In these applications, couriers are often responsible to transport the goods (e.g. parcels or food) for the requesters (e.g., customers). The origins of the requests can be the warehouses in e-commerce or the restaurants in food delivery platforms, while the destinations can be the workplaces or homes of the requesters. As such, a fundamental problem is route planning, which schedules multiple couriers' routes (i.e., sequences of origins and destinations) among the couriers and requests.

Various techniques exist that aim to solve the problem of route planning. These techniques are designed to enable efficient distribution of goods in an established geographic area. Traditionally, each delivery service typically divides its established geographic area into sub-regions which are fixed in nature. Conventional systems are unable to dynamically alter region boundaries in real-time or adjust regional assignment of delivery workers. Further, conventional systems are not able to cope with volume changes, vehicle's load limit and driver's efficiency or skill. Still further, conventional systems fail to incorporate the intelligence, experience and know-how of delivery workers while planning the routes and assigning loads. As such conventional systems prove to be inefficient in terms of distance covered by the delivery workers, time taken for successful deliveries; which, in turn, adds to the cost for the delivery service operator.

Hence, there is a need for a system and method that allows dynamic route planning and dynamic sub-region creation. Further, there is needed a system and method that understands driver's behaviours and patterns and their familiarity with a geographic region for optimizing delivery in real-time.

### SUMMARY

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

It is object of the invention to provide improved methods for identifying geographic constraints for optimizing dispatch plans.

It is an another object of the invention to provide improved methods for generating dynamic, optimal and real time dispatch plans.

The independent claims define the invention in various aspects. The dependent claims state selected elements of embodiments according to the invention in various aspects.

This summary is submitted with the understanding that it will not be used to interpret or limit the scope or meaning of the claims. This summary is not intended to identify key features or essential features of the claimed subject matter, nor is it intended to be used as an aid in determining the scope of the claimed subject matter. Other methods, apparatus and systems are also disclosed. Those skilled in the art will recognise additional features and advantages upon reading the following detailed description, and upon viewing the accompanying drawings.

### BRIEF DESCRIPTION OF THE DRAWINGS

Embodiments according to the claimed subject matter are described below with reference to the drawings. The detailed description references the accompanying figures. The same numbers can be used throughout the drawings to reference like features and components. As used herein, like terms refer to like elements throughout the description. It should be noted that views of exemplary embodiments are merely to illustrate selected features of the embodiment. The views qualitatively illustrate exemplary features of some embodiments and, therefore, should not be interpreted as being drawn to scale.

FIG. 1 is a block diagram schematically showing a system according to some embodiments of the present invention.

FIG. 2 illustrates a data storage module according to some embodiments of the present invention.

FIG. 3 illustrates a dynamic route planning system, according to one embodiment of the present invention.

FIG. 4 illustrates a method of generating real-time dynamic dispatch plans, according to one embodiment of the present invention.

### DETAILED DESCRIPTION

For purposes of explanation, numerous specific details are set forth in order to provide a thorough understanding of the claimed subject matter. It may be evident, however, that the claimed subject matter may be practised without these specific details. Also, in some instances, well-known features are omitted or simplified to clarify the description of the exemplary implementations. In some other instances, well-known features or units or circuits have been shown in block diagram form in order avoid clutter due to unnecessary detailing.

As used herein, the wording ‘dispatch’ may mean any task or a group of tasks undertaken by the dispatch agent. As such, a task may include, in no limiting sense, shipment delivery, shipment pickup, shipment return, document collection, document delivery, document verification or address verification.

As used herein, the wording ‘dispatch agent’ may include any means for performing the said dispatch. As such, a dispatch agent may be a human being performing dispatches. Not limiting, dispatch agents may also include autonomous or semi-autonomous robots, drones, UAVs, vehicles (e.g. self-driving cars) etc.

As used herein, the wording “entity” means any geographical area which may include, but not limited to, buildings, structures, monuments, road segments, railway tracks, water bodies, restricted areas, open areas such as parks, grounds, forests.

Reference will now be made to the drawings to describe the present invention in detail. The implementations herein are described in terms of exemplary embodiments. However, it should be appreciated that individual aspects of the implementations may be separately claimed and one or more of the features of the various embodiments may be combined.

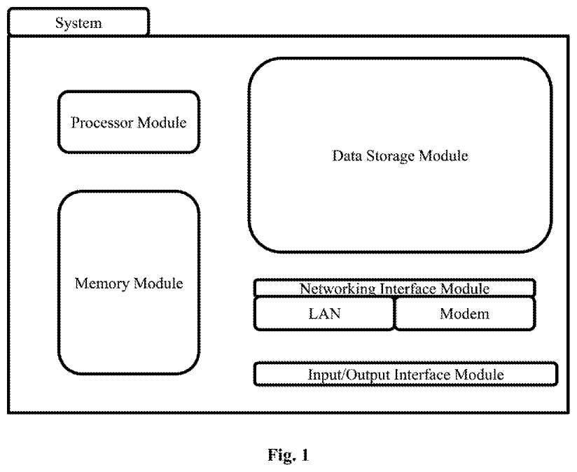

FIG. 1 is a block diagram schematically showing a system according to some embodiments of the present invention. As shown, the system may comprise at least one processing module, at least one data storage module operably coupled to the at least one processing module and at least one memory module operably coupled to the at least one processing module. The system may further include a networking interface, allowing the system to operate in a networked environment supporting connections to one or more remote computers, such as mobile devices and computing devices. The networking interface may include a modem and a local area network (LAN) interface. The modem and LAN interface may connect to external communication devices, such as mobile phone, computer system and laptops etc. via internet, WAN or other communication modes.

The memory module may be configured to store software used by the system such as an operating system, applications program and associated database. The memory module may further be configured to store instructions, executable by the processing module, for enabling the system to perform various functions.

The system may also include an input-output interface which may include, but not limited to, an interface for display, keyboard, mouse, keypad, speaker, haptic device, microphone, camera or other input-output techniques well known in the art.

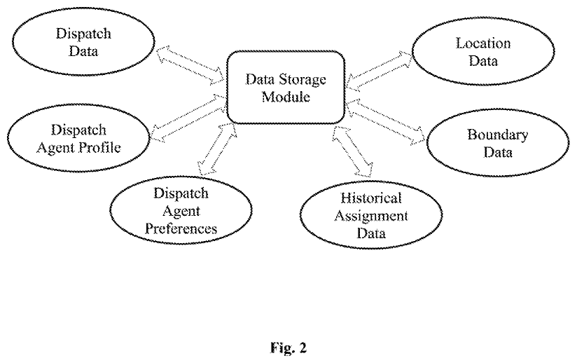

Referring the FIG. 2, there is shown a data storage module according to some embodiments of the present invention.

The data storage module may be configured to store dispatch data including a dispatch identifier that uniquely identifies a dispatch. The dispatch data may include attributes of one or more tasks covered under the dispatch such as, but not limited to, the weight and/or volume of shipments or packages, the type, capacity and/or other details of the vehicle used during the dispatch, time for completion of the one or more tasks etc. The dispatch data may also include historical delivery data such destination or dispatch addresses/geographical co-ordinates which were associated with a dispatch, clustering details showing a group of tasks undertaken in a single dispatch etc. In addition, the dispatch data may also reflect any preference of the dispatch agent such as preferred area of service, preferred time of service etc.

The data storage module may be configured to store addresses and/or geographic co-ordinates of entities. The entities may include origin entities such as distribution centres or warehouses as well as destination entities such as offices or homes. The entities may also include en-route or transitional entities such as road segments, railway tracks, water bodies, restricted areas, open areas such as parks, grounds, forests.

The data storage module may further be configured to store dispatch agent profiles, preferences, and historical assignment data. The dispatch agent profile may include personal details or attributes of the dispatch agent which may reflect the skill and efficiency of the dispatch agent to perform one or more tasks. An example of such attribute may be in form of a physical property such as weight or volume of the shipments or packages that the delivery agent can work with at a time. Another example may be a non-tangible property such as navigation skills of delivery agent.

The historical assignment data stored in the data storage module may include data regarding tasks historically undertaken by delivery agents. It is indicative of the location of origin entities, location of destination entities, the route followed by the dispatch agent, the time taken in completing the one or more tasks, among others.

The preferences of dispatch agents stored in the data storage module may include preferred areas of service, preferred times of service, preferred environmental conditions, preferred tasks etc. for dispatch agents. The data storage module may store the preferences explicitly for the dispatch agent. Additionally or alternatively, the data storage module in combination with the processor module may derive the preferences of the dispatch agents from the historical assignment data stored in the data storage module.

The data storage module may also store real time geo location data received from the delivery agent en route to undertaking the dispatch. The real time geo-location data is indicative of locations of en-route or transitional entities such as road segments, railway tracks, water bodies, restricted areas, open areas such as parks, grounds, forests.

The data storage module may also be configured to store boundary data. The boundary data corresponds to the boundary of a geographical area. The geographical area, bounded or unbounded, may represent a plurality of entities. A geographical area may have a continuous boundary or the boundary data may reflect one or more discontinuous boundaries.

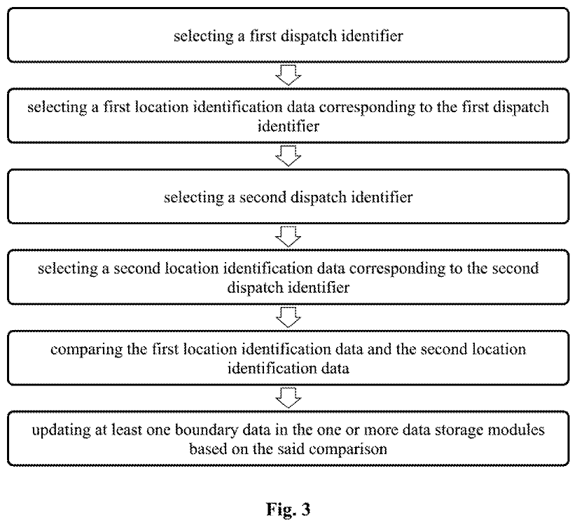

Referring now to FIG. 3, there is shown a dynamic route planning system, according to one embodiment of the present invention.

A first dispatch identifier is selected by the processing module in accordance with the instructions stored in memory module. The first dispatch identifier may be received by the processing module in real time from a remote communication device (not shown) or it may be pre-stored in data storage module.

Next, the processor module may select a second dispatch identifier. The processor module may process dispatch data corresponding to the first dispatch identifier to identify attributes of one or more tasks associated with the dispatch, or profile and/or preferences of the delivery agent. The processor module may select the second identifier based on this identified information.

As an example, in case the vehicle type associated with the first dispatch identifier is a heavy commercial vehicle such as a truck or lorry, it would imply that the first dispatch was undertaken by a heavy commercial vehicle. As such, the volume and/or weight of shipments serviced during this dispatch would generally be widely different than a dispatch with the associated vehicle type as a two-wheeler. Consequently, these dispatches would have different service areas as well. For example, a dispatch undertaken with a truck may service the whole city/town whereas a dispatch undertaken with a motor-cycle may service only a portion of the city such as a colony. Similarly, the type of tasks undertaken and the geographic areas serviced using a heavy commercial vehicle would be widely different than those undertaken by autonomous delivery agents such as a drone or a self-driving car.

Hence, the processor module is configured to select the second dispatch identifier that relates most closely with the first dispatch identifier based on the task attributes, profile, preferences of the delivery agents and/or historical assignment data.

The processor module may, then, select the location identification data corresponding to the first and the second dispatch identifiers. The location identification data may include address data and/or geo-location data of the entities associated with the first and second dispatches. The location identification data may also include real-time geo-location data corresponding to the route followed by the dispatch agent during the dispatch. The real-time geo-location data may be received from a remote communication device associated with the dispatch agent. The remote communication device may log the real-time location of the dispatch agent intermittently or periodically throughout the dispatch duration. As such, this data is indicative of the route followed and the entities serviced by the dispatch agent during the dispatch. The remote communication device may send this data to be stored on the data storage module in an intermittent manner, or a periodic manner. Alternatively, or in conjunction, the remote communication device may collect all real-time data during dispatch and send the complete log in one go to be stored on the data storage module.

Hence, the processor module selects the location identification data corresponding to the first and the second dispatch identifiers which is indicative of the address/location of the entities serviced during the dispatches as well as the route followed by the dispatch agents during these dispatches.

The processor module may, then, compare the degree of overlap between the location identification data associated with the first dispatch identifier and the second dispatch identifier.

In case the degree of overlap is more than a first threshold value, the processor module may designate the overlap region as a first geographic cluster. This is indicative that the location identification data of the first and the second dispatch identifiers is highly overlapping, thereby rendering that such overlap locations be serviced under a single dispatch.

In case the degree of overlap is lower than a second threshold value, the processor module may designate the regions comprising the geographic locations associated with the first dispatch identifier and the second dispatch identifier as separate geographic clusters. This is indicative that the location identification data of the first and the second dispatch identifiers is not overlapping to an extent that such locations may be serviced under a single dispatch.

The processor module may further designate the area between two geographic clusters as a geographic constraint boundary. The geographic constraint boundary reflects the separation between the two geographic clusters. A single geographic cluster may be surrounded by a plurality of other geographic clusters where each of the plurality of other geographic clusters share a geographic constraint boundary with the single geographic cluster. Hence, one geographic cluster may be bounded by a plurality of geographic constraint boundaries. As indicated above, the data storage module is capable of storing data related to these geographic constraint boundaries as boundary data.

The processor module may overlay the geographic locations associated with the first dispatch identifier and the second dispatch identifier on a terrestrial map. The processor module may use computer vision, machine learning, deep learning or any other associated techniques well known in the art to compute the degree of overlap.

In an another embodiment of the invention, to optimize, the processor module may also align and classify the geographic constraint boundary by comparing the boundary data with the features present in a relevant terrestrial map. As an example, if the geographic locations associated with the first dispatch identifier form a first geographic cluster on one side of a river and the geographic locations associated with the second dispatch identifier form a second geographic cluster on the other side of the river, the processor module may designate the river as a geographic constraint boundary. As such, the processor module may select the geographic constraint data, compare this data with relevant map data and classify the geographic constraint boundary as a river.

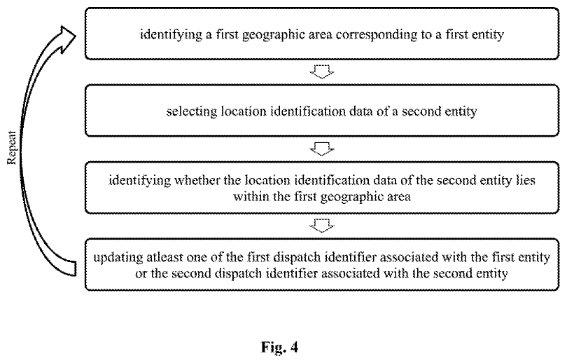

Referring now to FIG. 4, there is shown a method of generating real-time dynamic dispatch plans, according to one embodiment of the present invention. The processor module selects a first entity which is to be serviced during a dispatch. The processor module identifies a first geographic cluster associated with the first entity. The processor module identifies location identification data of a second entity and selects the second entity if the geographic location of the second entity lies within the first geographic cluster. The processor module may allocate a single dispatch identifier to the service to be made to the first and second entities, thereby clustering the first and second entities in a single dispatch. The processor module may repeat the above steps to populate the list of entities, thereby forming a dispatch plan.

The disclosure is operational with numerous other general purpose or special purpose computing system environments or configurations. Examples of well known computing systems, environments, and/or configurations that may be suitable for use with the disclosure include, but are not limited to, personal computers, server computers, handheld or laptop devices, multiprocessor systems, microprocessor-based systems, set top boxes, programmable consumer electronics, network PCs, minicomputers, mainframe computers, and distributed computing environments that include any of the above systems or devices, and the like.

1. A system comprising:
one or more processing modules;
one or more data storage modules, operatively coupled to the one or more processing modules, wherein the one or more data storage modules are configured to store at least one of:
dispatch data corresponding to at least one dispatch wherein the dispatch data includes a dispatch identifier;
location identification data wherein the location identification data comprises at least one of:
address data corresponding to address of an entity associated with at least one dispatch,
geo-location data corresponding to geographic location of an entity associated with at least one dispatch,
real-time geo-location data corresponding to the route associated with at least one dispatch; and
boundary data corresponding to boundary between two geographical areas each represented by a plurality of entities; and
at least one memory module operatively coupled to the one or more processing modules, wherein the at least one memory module stores instructions which, when executed by the one or more processing modules, causes the one or more processing modules to:
select a first dispatch identifier;
select a first location identification data corresponding to the first dispatch identifier;
select a second dispatch identifier;
select a second location identification data corresponding to the second dispatch identifier;
compare the first location identification data and the second location identification data; and
update at least one boundary data in the one or more data storage modules based on the said comparison.

2. The system of claim 1, wherein the dispatch data further includes at least one of:
physical attributes associated with the dispatch such as weight, volume or the packages, type and capacity of delivery agents;
non-physical attributes associated with the dispatch such as navigation skills of delivery agents; and
preferences of delivery agents associated with the dispatch.

3. The system of claim 1, wherein the one or more processing modules further compares first dispatch data having a first dispatch identifier and second dispatch data having a second dispatch identifier to select the first and second dispatch identifiers.

4. The system of claim 3, wherein the one or more processing modules selects the first and second dispatch identifiers when the first and second dispatch data have similar physical attributes, non-physical attributes and/or preferences.

5. The system of claim 1, wherein the one or more processing modules further:
selects a first boundary data;
selects a first map data,
wherein the map data corresponds to a geographical area bounded, at least partially, by the first boundary data;
compares the first boundary data and the first map data; and
classifies at least a portion of the first boundary data.

6. A method of generating dynamic dispatch plan, the comprising:
identifying a first geographic area corresponding to a first entity;
selecting location identification data of a second entity;
identifying whether the location identification data of the second entity lies within the first geographic area; and
updating at least one of a first dispatch identifier associated with the first entity or a second dispatch identifier associated with the second entity.
